(19) United States
(12) Patent Application Publication
(10) Pub. No.: US 2025/0323455 A1
(43) Pub. Date: Oct. 16, 2025

(54) CONNECTOR ASSEMBLY

(71) Applicant: Japan Aviation Electronics Industry, Limited, Tokyo (JP)

(72) Inventor: Keisuke NAKAMURA, Tokyo (JP)

(21) Appl. No.: 19/071,447

(22) Filed: Mar. 5, 2025

(30) Foreign Application Priority Data
Apr. 10, 2024 (JP) 2024-063478

(51) Int. Cl. H01R 13/621; H01R 13/518; H01R 13/629; H01R 103/00

(52) U.S. Cl. CPC H01R 13/6215; H01R 13/518; H01R 13/629; H01R 2103/00

(57) ABSTRACT

A connector assembly includes a first connector having a first insulator, a first contact and a slider, and a second connector having a second insulator, a second contact and a screw member, the slider including a slider body portion and a pressing portion, when the second insulator is situated at a contact position to contact the first insulator, the second contact opposes the first contact with a predetermined gap from the first contact, and when the screw member is rotated, the slider slides in the fitting direction, the first insulator is pressed against the second insulator by the slider body portion whereby the first connector and the second connector are fitted together, and the first contact and the second contact are pressed against each other by the pressing portion to be thereby electrically connected to each other.

### BACKGROUND OF THE INVENTION

The present invention relates to a connector assembly, in particular, to a connector assembly in which a first connector and a second connector are fitted to each other along a fitting direction.

There has been conventionally known a so-called bolt assisted connector assembly in which a first connector and a second connector are fitted to each other with use of bolt fastening power by bolting the first connector to the second connector.

For instance, JP 2024-8643 A discloses a connector assembly comprising a first connector 1 and a second connector 2 that is connected to ends of electric wires L and is fitted to the first connector 1 along a fitting direction D, as shown in FIG. 21. The first connector 1 includes a first housing 3 and a first contact 4 held by the first housing 3, and the second connector 2 includes a second housing 5, a second contact (not shown) held in the second housing 5, and a fastening bolt 6 penetrating the second housing 5 in the fitting direction D.

The second connector 2 is pressed against the first connector 1 in the fitting direction D, and the fastening bolt 6 of the second connector 2 is rotated and is thus screwed to a nut (not shown) embedded in the first housing 3 of the first connector 1, whereby the second housing 5 is fastened to the first housing 3, achieving the fitted state between the first connector 1 and the second connector 2 as shown in FIG. 22. As a result, the columnar first contact 4 of the first connector 1 and a cylindrical second contact 7 of the second connector 2 are brought into contact with and electrically connected to each other.

In the meantime, when the fastening bolt 6 of the second connector 2 is rotated to be screwed to the nut in the first connector 1 for fitting the second connector 2 to the first connector 1, the columnar first contact 4 is press-fitted into the cylindrical second contact 7 along the fitting direction D. Hence, the first contact 4 and the second contact 7 may wear as a result of the fitting operation of the first connector 1 and the second connector 2. As the wear of the first contact 4 and the second contact 7 proceeds, plating on surfaces of the first contact 4 and the second contact 7 would be scraped off to thereby impair the reliability of electric connection.

Specifically, in a connector assembly to which high current is applied via the electric wire L, the first contact 4 and the second contact 7 have increased sizes while the electric wire L has an increased diameter, leading to higher contact force between the first contact 4 and the second contact 7, and therefore the wear occurring in these contacts would not be ignorable.

### SUMMARY OF THE INVENTION

The present invention has been made to solve the foregoing conventional problem and aims at providing a connector assembly that can improve the reliability of electric connection between a first contact and a second contact while a first connector and a second connector are easily fitted together.

The connector assembly according to the invention is a connector assembly in which a second connector is fitted to a first connector along a fitting direction, wherein the first connector includes a first insulator, a first contact held by the first insulator, and a slider including a female screw portion and held by the first insulator to be slidable along the fitting direction, the second connector includes a second insulator, a second contact held by the second insulator, and a screw member including a male screw portion and held by the second insulator to be rotatable while penetrating the second insulator in the fitting direction, the male screw portion being able to be screwed to the female screw portion, the slider includes a slider body portion extending in an orthogonal direction orthogonal to the fitting direction and provided with the female screw portion, and a pressing portion extending in the fitting direction from the slider body portion, when the second insulator is situated at a contact position to contact the first insulator in the fitting direction, the second contact opposes the first contact in the orthogonal direction with a predetermined gap from the first contact, and when the screw member is rotated while the second insulator is situated at the contact position with respect to the first insulator, the male screw portion is screwed to the female screw portion whereby the slider slides in the fitting direction, the first insulator is pressed against the second insulator by the slider body portion whereby the first connector and the second connector are fitted together, and the first contact and the second contact are pressed against each other in the orthogonal direction by the pressing portion to be thereby electrically connected to each other.

### BRIEF DESCRIPTION OF THE DRAWINGS

FIG. 1 is a perspective view of a connector assembly according to an embodiment when viewed from an obliquely upper position.

FIG. 2 is a perspective view of the connector assembly according to the embodiment when viewed from an obliquely lower position.

FIG. 3 is a perspective view of a first connector used in the embodiment when viewed from an obliquely upper position.

FIG. 4 is a perspective view of the first connector used in the embodiment when viewed from an obliquely lower position.

FIG. 5 is a plan view of the first connector used in the embodiment.

FIG. 6 is a cross-sectional view taken along line A-A in FIG. 5.

FIG. 7 is a perspective view of a slider used in the embodiment when viewed from an obliquely upper position.

FIG. 8 is a perspective view of the slider used in the embodiment when viewed from an obliquely lower position.

FIG. 9 is a cross-sectional front view showing the slider used in the embodiment.

FIG. 10 is a perspective view of a second connector used in the embodiment when viewed from an obliquely upper position.

FIG. 11 is a perspective view of the second connector used in the embodiment when viewed from an obliquely lower position.

FIG. 12 is a plan view of the second connector used in the embodiment.

FIG. 13 is a bottom view of the second connector used in the embodiment.

FIG. 14 is a cross-sectional view taken along line B-B in FIG. 12.

FIG. 15 is a cross-sectional front view showing a frame member used in the embodiment.

FIG. 16 is an enlarged partial view of FIG. 14.

FIG. 17 is a cross-sectional front view showing a state where a second insulator of the second connector is situated at a contact position to contact a first insulator of the first connector.

FIG. 18 is a cross-sectional front view schematically showing a positional relationship between the first contact, the second contact, the frame member, and a pressing portion of the slider in the state where the second insulator of the second connector is situated at the contact position to contact the first insulator of the first connector.

FIG. 19 is a cross-sectional front view showing a fitted state between the first connector and the second connector.

FIG. 20 is a cross-sectional front view schematically showing a positional relationship between the first contact, the second contact, the frame member, and the pressing portion of the slider in the fitted state between the first connector and the second connector.

FIG. 21 is a perspective view showing a conventional connector assembly before fitting.

FIG. 22 is a cross-sectional view showing the conventional connector assembly in the fitted state.

### DETAILED DESCRIPTION OF THE INVENTION

An embodiment of the invention is described below based on the accompanying drawings.

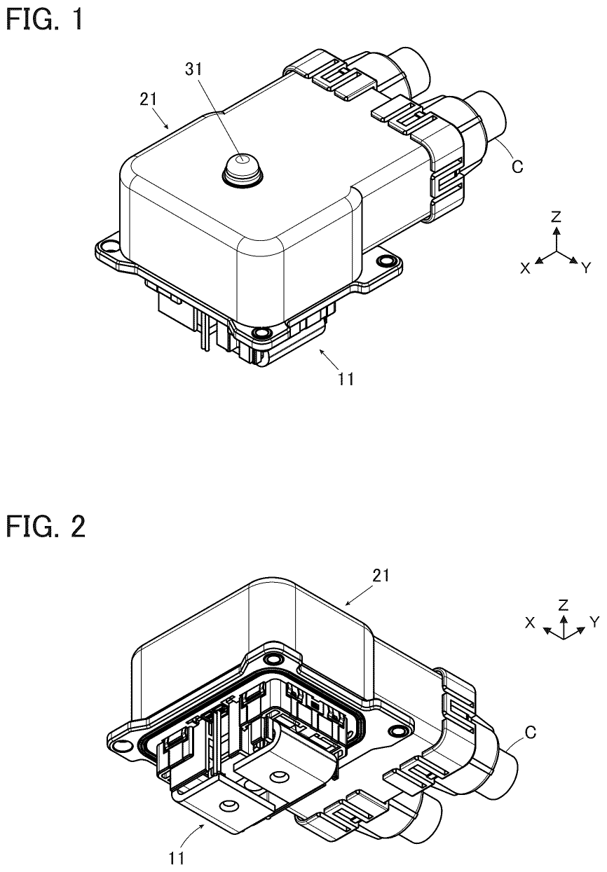

FIGS. 1 and 2 show a connector assembly according to the embodiment. The connector assembly includes a first connector 11 and a second connector 21 that is fitted to the first connector 11 along a fitting direction. For instance, the first connector 11 is mounted on an electric device (not shown) while the second connector 21 is attached to ends of two mutually parallel electric wires C, whereby the connector assembly can detachably connect the two electric wires C to the electrical device.

Fitting and detachment between the first connector 11 and the second connector 21 are carried out by rotating a screw member 31 included in the second connector 21.

For convenience, the direction of fitting between the first connector 11 and the second connector 21 is referred to as “Z direction,” the direction in which the two mutually parallel electric wires C are aligned as “Y direction” (orthogonal direction), and the direction orthogonal to the Z direction and the Y direction as “X direction.”

The second connector 21 is moved from the +Z direction to the −Z direction to be fitted to the first connector 11.

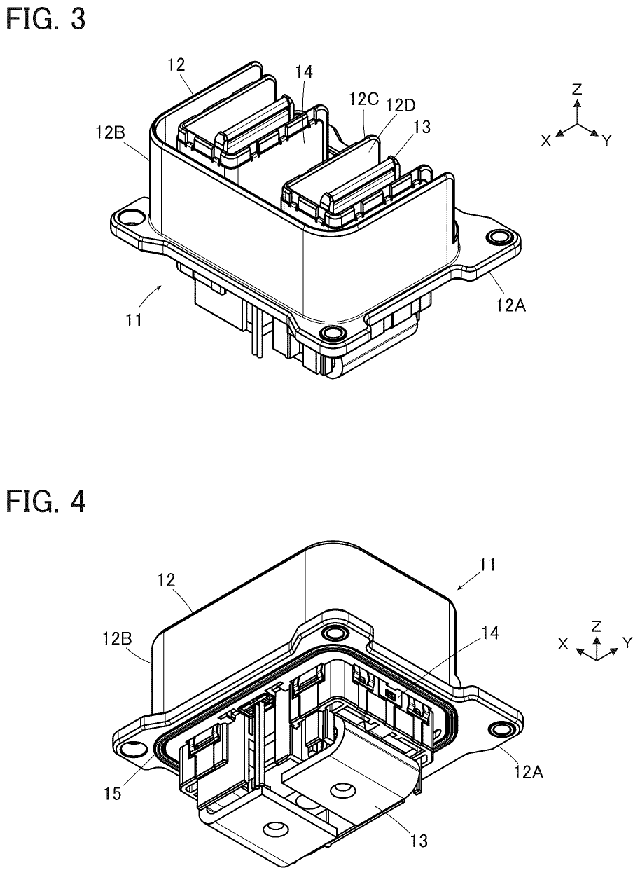

FIGS. 3 and 4 show the first connector 11. The first connector 11 includes a first insulator 12, a pair of first contacts 13 held by the first insulator 12, a pair of metal shells 14 corresponding to the pair of first contacts 13, and a waterproof packing 15 for device mounting use.

The first insulator 12 is made of an insulating resin material and includes a flat plate portion 12 extending along an XY plane, and a frame-shaped outer wall portion 12B extending in the +Z direction from the flat plate portion 12A and having a U shape opening toward the −X direction when viewed from the Z direction. Inside the outer wall portion 12B, provided is a pair of protruding portions 12C arranged to be aligned in the Y direction. The pair of protruding portions 12C each have a U shape opening toward the −X direction when viewed from the Z direction and extend in the Z direction. The interior of each protruding portion 12C forms a second contact accommodating portion 12D of recess shape opening toward the +Z direction and extending in the Z direction.

The pair of first contacts 13 are made of a metal material having conductivity and are held by the first insulator 12 through, for example, press-fitting. A +Z directional portion of each first contact 13 extends in the +Z direction along an XZ plane and projects in the corresponding second contact accommodating portion 12D of the first insulator 12. Outer lateral surfaces of the pair of protruding portions 12C are each covered by a corresponding metal shell 14. A −Z directional portion of each first contact 13 is bent toward the Y direction and extends along an XY plane on the −Z direction side of the first insulator 12.

The waterproof packing 15 for device mounting use is made of an elastic material such as rubber and disposed on the bottom surface, facing the −Z direction, of the flat plate portion 12A.

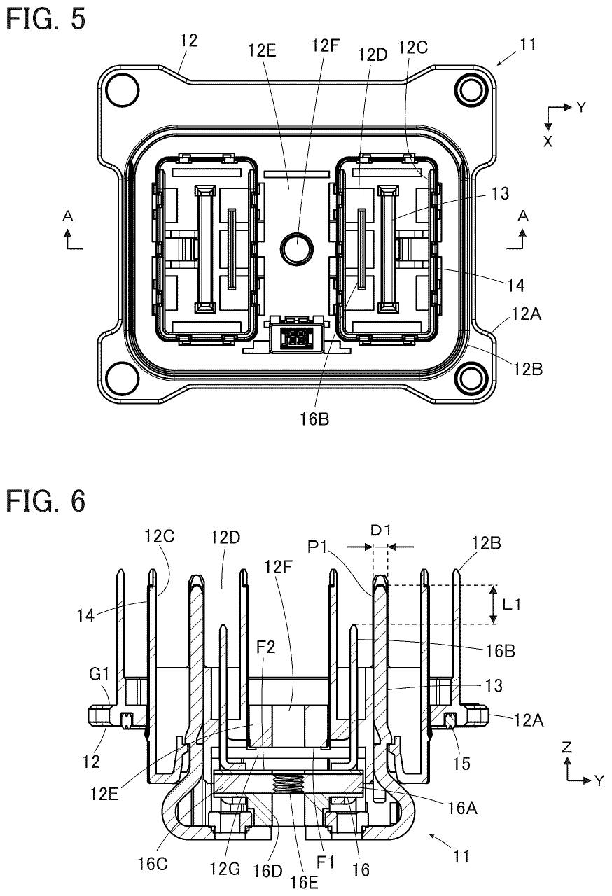

As illustrated in FIG. 5, the first insulator 12 includes an insulator center portion 12E disposed between the pair of protruding portions 12C, and the insulator center portion 12E is provided with a communicating hole 12F penetrating the first insulator 12 in the Z direction.

As illustrated in FIG. 6, the insulator center portion 12E has a thickness larger than the thickness of the flat plate portion 12A in the Z direction and is provided with a slider accommodating portion 12G of recess shape opening toward the −Z direction on the −Z direction side of the insulator center portion 12E. The communicating hole 12F penetrates the insulator center portion 12E in the Z direction so as to communicate with an inside of the slider accommodating portion 12G. Of the insulator center portion 12E, the −Z directional surface facing the slider accommodating portion 12G forms a fastening force receiving surface F1 extending along an XY plane.

In addition, of the flat plate portion 12A, the +Z directional surface of a portion situated on the outside of the outer wall portion 12B forms a first opposing surface G1 extending along an XY plane and facing the +Z direction.

In addition, as illustrated in FIG. 6, the first connector 11 includes a slider 16 that is held by the first insulator 12 in such a manner that the slider 16 can slide along the Z direction, i.e., the fitting direction between the first connector 11 and the second connector 21.

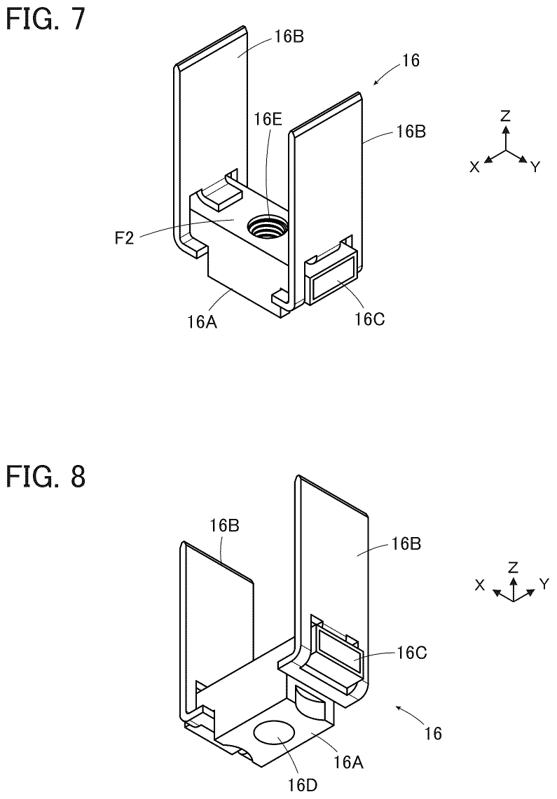

As illustrated in FIGS. 7 and 8, the slider 16 includes a slider body portion 16A extending in the Y direction along an XY plane, and a pair of pressing portions 16B extending along the +Z direction separately from the +Y directional end portion and the −Y directional end portion of the slider body portion 16A.

The slider body portion 16A has a configuration in which a metal member 16C of flat plate shape extending in the Y direction along an XY plane is insert-molded with a resin material, and a through-hole 16D is formed in a center part in the Y direction of the slider body portion 16A so as to penetrate the slider body portion 16A in the Z direction. The +Z directional surface of the slider body portion 16A forms a fastening force applying surface F2 extending along an XY plane.

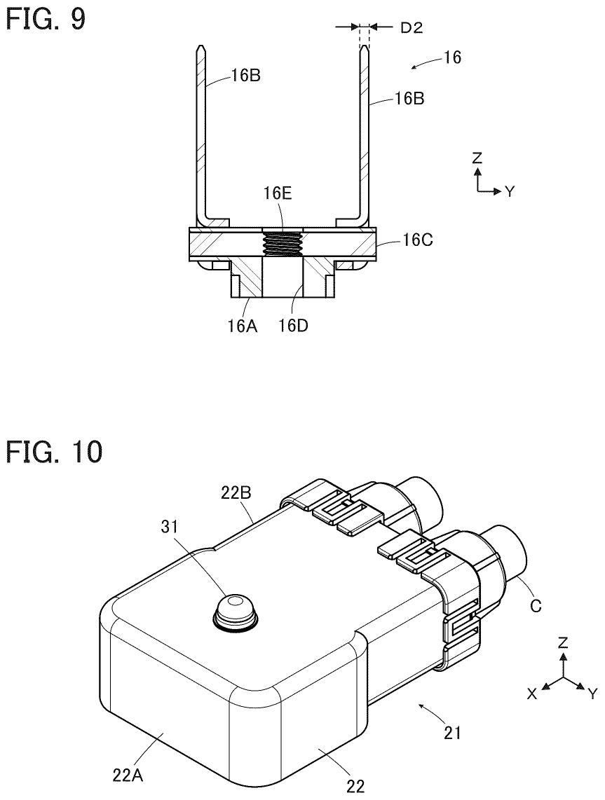

As illustrated in FIG. 9, the metal member 16C of the slider body portion 16A is provided with a female screw portion 16E extending in the Z direction coaxially with the through-hole 16D.

The pair of pressing portions 16B are each made of a metal material, have a flat plate shape extending in the +Z direction from the slider body portion 16A along an XZ plane, and have a thickness D2 in the Y direction.

As illustrated in FIG. 6, the slider 16 is held by the first insulator 12 in a slidable manner along the Z direction while the slider body portion 16A is accommodated in the slider accommodating portion 12G of recess shape of the first insulator 12 and the pair of pressing portions 16B each project into the corresponding second contact accommodating portion 12D of the first insulator 12.

Since the −Z directional end portion of the slider body portion 16A comes into contact with bending portions of the pair of first contacts 13 extending along an XY plane on the −Z direction side of the first insulator 12, the −Z directional end of the slidable range of the slider 16 is defined.

As illustrated in FIG. 6, the slider 16 is configured such that when the slider 16 is situated at the −Z directional end of its slidable range, the +Z directional ends of the pair of pressing portions 16B are situated away from the +Z directional ends of the pair of first contacts 13 on the −Z direction side by a predetermined distance L1.

Meanwhile, the +Z directional portions of the pair of first contacts 13 extending in the +Z direction along an XZ plane each form a first contact portion P1 and have a thickness D1 in the Y direction.

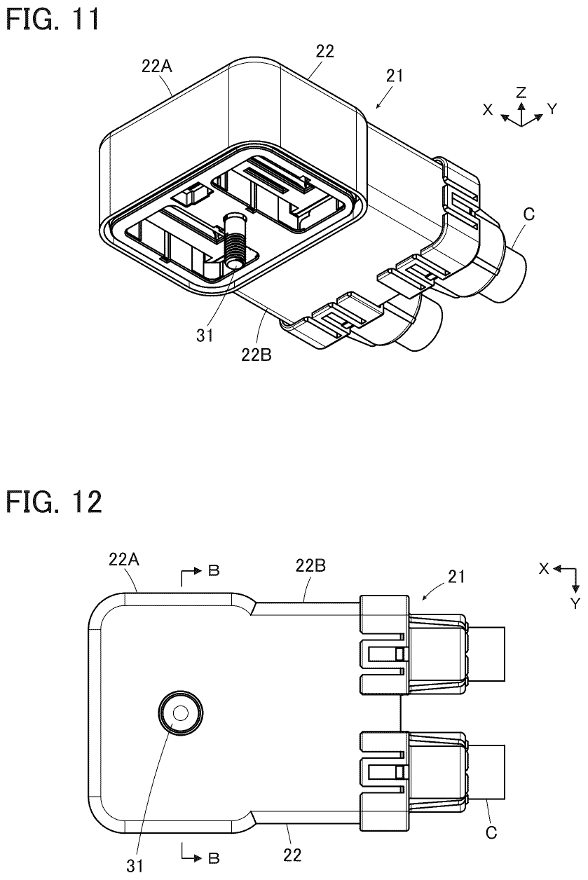

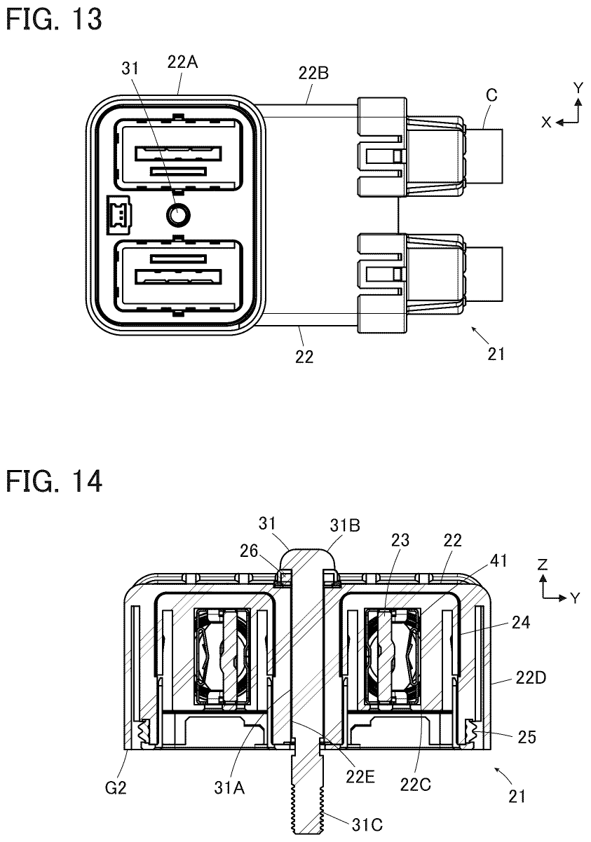

FIGS. 10 to 13 show the second connector 21 attached to ends of the two mutually parallel electric wires C. The second connector 21 includes a second insulator 22, a pair of second contacts to be described later that are held by the second insulator 22 and connected to the ends of the two electric wires C, and a screw member 31 held by the second insulator 22 in a rotatable manner while penetrating the second insulator 22 in the Z direction.

The second insulator 22 includes a fitting portion 22A of tubular shape made of an insulating resin material and extending in the Z direction, and an electric wire connection portion 22B of tubular shape joined to the −X direction side of the fitting portion 22A and extending in the X direction. The fitting portion 22A opens toward the −Z direction and accommodates part of the first connector 11 when the first connector 11 and the second connector 21 are fitted together. The screw member 31 penetrates the fitting portion 22A in the Z direction. The electric wire connection portion 22B opens toward the −X direction and accommodates the ends of the two electric wires C.

As illustrated in FIG. 14, in an interior of the fitting portion 22A, a pair of second contacts 23 are disposed separately on opposite sides of the screw member 31 in the Y direction so as to sandwich the screw member 31. The pair of second contacts 23 are made of a conductive metal material, and each of the second contacts 23 is electrically connected to an end of the corresponding electric wire C and has a flat plate shape extending in the +X direction along an XZ plane.

A pair of frame member accommodating portions 22C of recess shape are formed inside the fitting portion 22A to correspond to the pair of second contacts 23, and a frame member 41 is accommodated in each of the frame member accommodating portions 22C. The second contacts 23 are held in the fitting portion 22A of the second insulator 22 such that the second contacts 23 are each situated in the corresponding frame member 41.

A +Z directional portion of each of the pair of second contacts 23 is covered by a corresponding metal shell 24.

The second insulator 22 includes an outer wall portion 22D surrounding the periphery of the fitting portion 22A and extending in the −Z direction, and the −Z directional end of the outer wall portion 22D forms a second opposing surface G2 extending along an XY plane and facing the −Z direction.

Inside the −Z directional end of the outer wall portion 22D, disposed is a fitting portion waterproof packing 25 formed of an elastic material such as rubber.

The screw member 31 includes a screw body portion 31A which extends in the Z direction and is passed through the screw member through-hole 22E formed in the fitting portion 22A, and a screw head portion 31B joined to the +Z directional end of the screw body portion 31A. The screw head portion 31B has a diameter larger than the diameter of the screw body portion 31A and is exposed on the +Z direction side of the fitting portion 22A. In addition, a male screw portion 31C is formed at the −Z directional end of the screw body portion 31A over a predetermined length in the Z direction. The male screw portion 31C has a size and a pitch with which the male screw portion 31C can be screwed to the female screw portion 16E formed in the slider body portion 16A of the slider 16 that is disposed in the first connector 11.

Moreover, in the fitting portion 22A, disposed is a screw member waterproof packing 26 surrounding the periphery of the screw body portion 31A and contacting the screw head portion 31B.

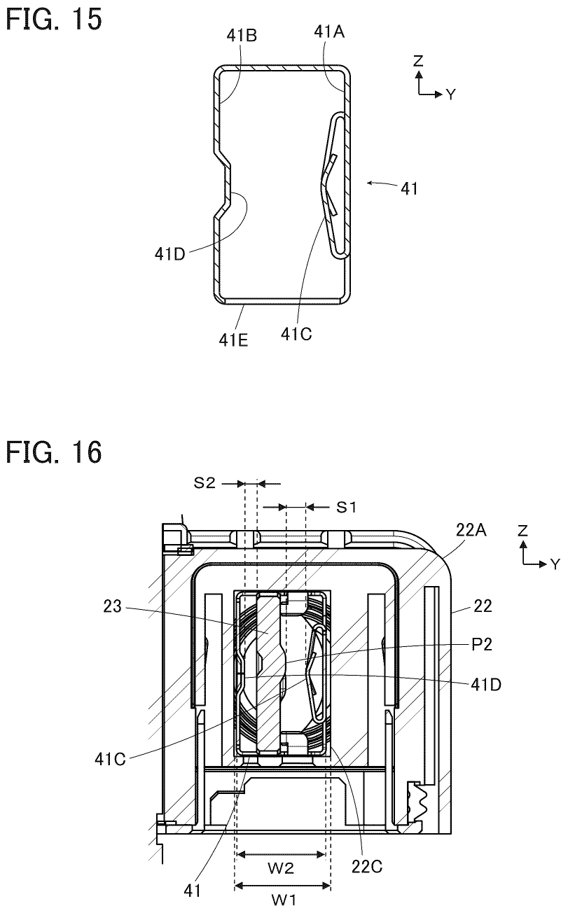

As illustrated in FIG. 15, the frame member 41 is made of a tubular metal sheet having a substantially rectangular YZ cross section and extending in the X direction and includes a pair of inner wall surfaces 41A and 41B opposing each other in the Y direction. On one of the surfaces, i.e., the inner wall surface 41A, a spring portion 41C is formed, while a projection 41D is formed on the other one of the surfaces, i.e., the inner wall surface 41B.

The spring portion 41C is formed to be elastically deformable in the Y direction by providing a cut to the metal sheet constituting the frame member 41 and bending the metal sheet. The projection 41D is also formed by bending the metal sheet constituting the frame member 41 and projects toward an interior of the frame member 41 at a position in the Z direction corresponding to the spring member 41C.

The frame member 41 is provided at the −Z directional end thereof with an opening portion 41E and is configured such that the first contact 13 and the pressing portion 16B of the slider 16 can be inserted into the frame member 41 from the −Z direction through the opening portion 41E.

As illustrated in FIG. 16, a width W2 of the frame member 41 in the Y direction is smaller than a width W1 of the frame member accommodating portion 22C of the second insulator 22 in the Y direction. Hence, the frame member 41 is configured to be movable in the Y direction inside the frame member accommodating portion 22C within the range of (W1-W2).

Of the second contact 23, a portion opposing the spring portion 41C projects in the Y direction toward the spring portion 41C, and this projecting portion forms a second contact portion P2.

With the spring portion 41C receiving no force acting in the Y direction, i.e., when the spring portion 41C is in a natural state, the sum of a gap S1 between the second contact portion P2 of the second contact 23 and the spring portion 41C and a gap S2 between the second contact 23 and the projection 41D in the Y direction is larger than the thickness D1 of the first contact 13 in the Y direction (FIG. 6) and smaller than the sum of the thickness D1 of the first contact 31 and the thickness D2 of the pressing portion 16B of the slider 16 (FIG. 9).

Furthermore, since the frame member 41 moves in the Y direction inside the frame member accommodating portion 22C within the range of (W1-W2), the gap S1 between the second contact portion P2 of the second contact 23 and the spring portion 41C in the Y direction can have a larger value than that of the thickness D1 of the first contact 13.

The first contact 13 alone can be hence inserted between the second contact portion P2 of the second contact 23 and the spring portion 41C in the frame member 41 through the opening portion 41E without rubbing against the second contact 23 and the spring portion 41C.

Meanwhile, with the spring portion 41C being in a natural state, the sum of the gap S1 between the second contact portion P2 of the second contact 23 and the spring portion 41C and the gap S2 between the second contact 23 and the projection 41D in the Y direction is smaller than the sum of the thickness D1 of the first contact 13 and the thickness D2 of the pressing portion 16B of the slider 16 in the Y direction; therefore, when the first contact 13 is inserted between the second contact portion P2 of the second contact 23 and the spring portion 41C at the same time as the pressing portion 16B of the slider 16 is inserted between the second contact 23 and the projection 41D, the spring portion 41C cannot maintain the natural state and is brought into a state of being elastically compressed in the Y direction.

Next, the fitting operation between the first connector 11 and the second connector 21 will be described.

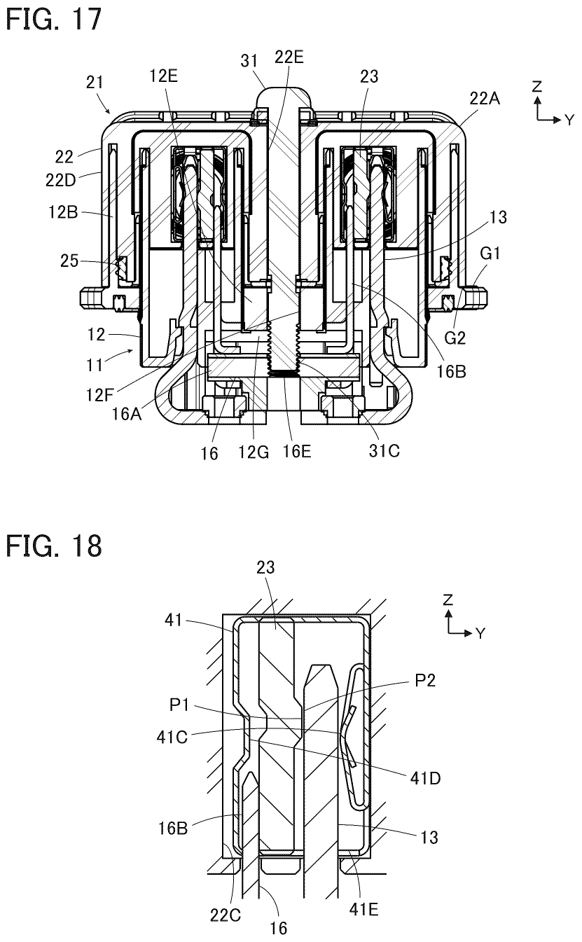

The second connector 21 is first moved in the −Z direction relatively to the first connector 11, and as illustrated in FIG. 17, part of the first connector 11 is accommodated in the fitting portion 22A of the second connector 21, whereby the second insulator 22 of the second connector 21 is brought to a contacting position contacting the first insulator 12 of the first connector 11.

Accordingly, the outer wall portion 12B of the first insulator 12 is inserted in an interior of the outer wall portion 22D of the second insulator 22 to come into contact with the fitting portion waterproof packing 25, and in addition, the second opposing surface G2 of the second insulator 22 comes into contact with the first opposing surface G1 of the first insulator 12.

The screw member 31 is passed through the screw member through-hole 22E of the fitting portion 22A and the communicating hole 12F in the insulator center portion 12E of the first insulator 12. At this time, the slider 16 disposed in the first connector 11 is situated at the −Z directional end of the slidable range, and a tip end of the male screw portion 31C of the screw member 31 is in contact with the +Z directional end of the female screw portion 16E formed in the slider body portion 16A of the slider 16.

With the second insulator 22 being situated at the contacting position contacting the first insulator 12, the first contact portion P1 of the first contact 13 extending in the +Z direction along an XZ plane is inserted between the second contact portion P2 of the second contact 23 and the spring portion 41C in the corresponding frame member 41 through the opening portion 41E as illustrated in FIG. 18. Since the slider 16 of the first connector 11 is situated at the −Z directional end of the slidable range, the +Z directional end of each pressing portion 16B is situated away from the +Z directional end of the first contact 13 on the −Z direction side by the predetermined distance L1, as illustrated in FIG. 6.

This constitution allows the pressing portion 16B of the slider 16 to be situated on the −Z direction side of the projection 41D of the frame member 41, and the first contact 13 can be thereby disposed between the second contact portion P2 of the second contact 23 and the spring portion 41C without rubbing against the second contact 23 and the spring portion 41C. In other words, the first contact 13 and the second contact 23 come to oppose each other in the Y direction with a predetermined gap therebetween.

Subsequently, by bringing a tool such as a driver or a wrench into contact with the screw head portion 31B of the screw member 31 and rotating the screw member 31, the male screw portion 31C of the screw member 31 is screwed to the female screw portion 16E formed in the slider body portion 16A of the slider 16.

The slider body portion 16A of the slider 16 hence moves in the +Z direction within the slider accommodating portion 12G following the rotation of the screw member 31.

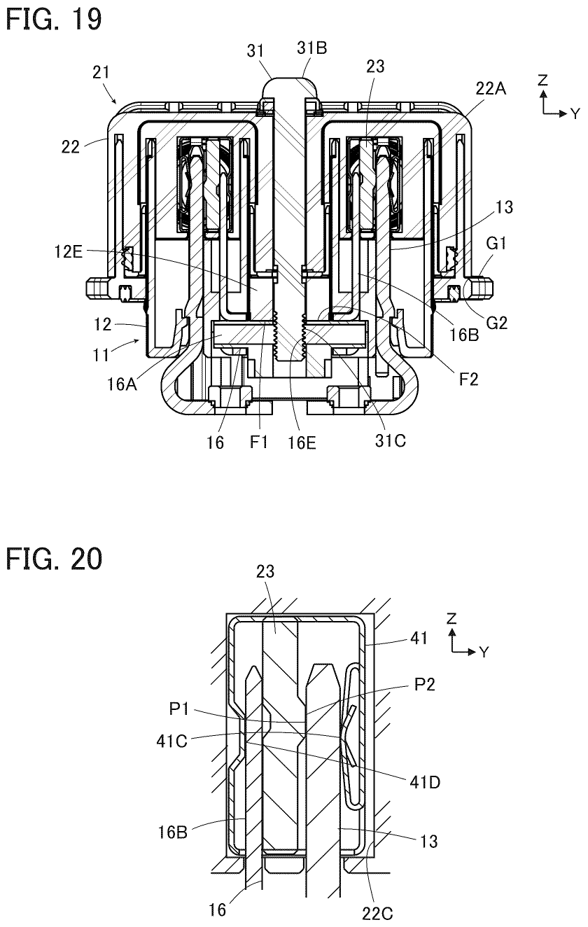

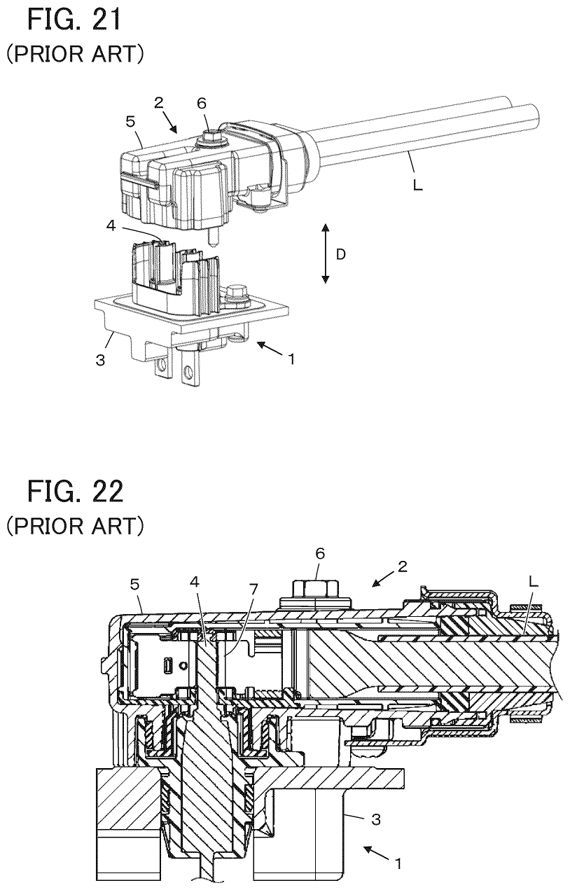

As illustrated in FIG. 19, when the slider 16 is moved to the +Z directional end of the slidable range, the fastening force applying surface F2 formed of the +Z directional surface of the slider body portion 16A comes into contact with the fastening force receiving surface F1 formed of the −Z directional surface of the insulator center portion 12E of the first insulator 12, and the fastening force receiving surface F1 is pressed in the +Z direction by the fastening force applying surface F2.

In this process, since the screw head portion 31B of the screw member 31 is exposed on the +Z direction side of the fitting portion 22A, the insulator center portion 12E and the fitting portion 22A are sandwiched between the screw head portion 31B and the slider body portion 16A.

As a result, the first opposing surface G1 of the first insulator 12 is pressed against the second opposing surface G2 of the second insulator 22, and the first insulator 12 is fastened to the second insulator 22. Accordingly, the first connector 11 and the second connector 21 are fitted together.

Moreover, when the slider 16 is moved to the +Z directional end of the slidable range, the pressing portion 16B of the slider 16 is moved in the +Z direction and is inserted between the projection 41D and the second contact 23 in the frame member 41 as illustrated in FIG. 20. It is noted that when the spring portion 41C is in a natural state, the sum of the gap between the second contact portion P2 of the second contact 23 and the spring portion 41C and the gap between the second contact 23 and the projection 41D in the Y direction is smaller than the sum of the thickness of the first contact 13 and the thickness of the pressing portion 16B of the slider 16 in the Y direction.

Hence, the frame member 41 is moved in the Y direction within the frame member accommodating portion 22C following insertion of the pressing portion 16B between the projection 41D and the second contact 23, whereby the spring portion 41C is elastically compressed in the Y direction.

As a result, due to elastic force of the spring portion 41C, the first contact portion P1 of the first contact 13 and the second contact portion P2 of the second contact 23 are pressed against each other in the Y direction to be thereby electrically connected to each other.

Similarly, the pair of second contacts 23 disposed on opposite sides of the screw member 31 in the Y direction are each electrically connected to the corresponding first contact 13.

It should be noted that FIG. 18 and FIG. 20 both illustrate, among the pair of second contacts 23 disposed on opposite sides of the screw member 31 in the Y direction, the second contact 23 disposed on the +Y direction side together with its corresponding frame member 41, first contact 13, and pressing portion 16B; in the meantime, the second contact 23 disposed on the −Y direction side of the screw member 31 is merely symmetric to the illustration with respect to the Y direction and has the same positional relationship with its corresponding frame member 41, first contact 13, and pressing portion 16B.

As described above, when the second insulator 22 is brought to the contacting position contacting the first insulator 12, the first contact 13 can be disposed between the second contact portion P2 of the second contact 23 and the spring portion 41C without rubbing against the second contact 23 and the spring portion 41C. By rotating the screw member 31 in this state, the first insulator 12 and the second insulator 22 can be fastened to each other, and the first contact portion P1 of the first contact 13 and the second contact portion P2 of the second contact 23 can be electrically connected to each other.

Thus, it is possible to improve reliability of the electric connection between the first contact 13 and the second contact 23, while the first connector 11 and the second connector 21 are easily fitted together.

To release the fitting between the first connector 11 and the second connector 21 that are fitted together with the first contact 13 and the second contact 23 being electrically connected to each other, it is sufficient if the screw member 31 is rotated in the opposite direction from the fitting operation to thereby move the slider 16 in the −Z direction, the male screw portion 31C of the screw member 31 is unscrewed from the female screw portion 16E of the slider 16, and the second connector 21 is thereafter pulled up relatively in the +Z direction with respect to the first connector 11 to be detached from the first connector 11.

With the first connector 11 and the second connector 21 being fitted together, the fitting portion waterproof packing 25 and the screw member waterproof packing 26 act to prevent water, dust, or the like from entering interiors of the first insulator 12 and the second insulator 22 from the outside.

In the above-described embodiment, the frame member 41 is disposed in the frame member accommodating portion 22C of the second insulator 22 to be movable in the Y direction, but this is not the sole case. For instance, the connector assembly may be configured such that the frame member 41 is disposed and fixed in the second insulator 22, the first contact portion P1 of the first contact 13 and the second contact portion P2 of the second contact 23 are disposed in the frame member 41 to be elastically displaceable, and the pressing portions 16B of the slider 16 are each inserted between the second contact 23 and the projection 41D of the frame member 41, whereby the first contact portion P1 of the first contact 13 and the second contact portion P2 of the second contact 23 are pressed against each other due to the spring portion 41C to be electrically connected to each other.

In the above-described embodiment, the pair of first contacts 13 of the first connector 11 are electrically connected to the pair of second contacts 23 of the second connector 21, but this is not the sole case. It is sufficient if one or more first contacts 13 are configured to be electrically connected to one or more second contacts 23.

What is claimed is:

1. A connector assembly in which a second connector is fitted to a first connector along a fitting direction,
wherein the first connector includes a first insulator, a first contact held by the first insulator, and a slider including a female screw portion and held by the first insulator to be slidable along the fitting direction,
the second connector includes a second insulator, a second contact held by the second insulator, and a screw member including a male screw portion and held by the second insulator to be rotatable while penetrating the second insulator in the fitting direction, the male screw portion being able to be screwed to the female screw portion,
the slider includes a slider body portion extending in an orthogonal direction orthogonal to the fitting direction and provided with the female screw portion, and a pressing portion extending in the fitting direction from the slider body portion,
when the second insulator is situated at a contact position to contact the first insulator in the fitting direction, the second contact opposes the first contact in the orthogonal direction with a predetermined gap from the first contact, and
when the screw member is rotated while the second insulator is situated at the contact position with respect to the first insulator, the male screw portion is screwed to the female screw portion whereby the slider slides in the fitting direction, the first insulator is pressed against the second insulator by the slider body portion whereby the first connector and the second connector are fitted together, and the first contact and the second contact are pressed against each other in the orthogonal direction by the pressing portion to be thereby electrically connected to each other.

2. The connector assembly according to claim 1,
wherein the first insulator includes a first opposing surface extending along the orthogonal direction and facing the second insulator,
the second insulator includes a second opposing surface extending along the orthogonal direction and opposing the first opposing surface, and
the first opposing surface and the second opposing surface make contact with each other at the contact position.

3. The connector assembly according to claim 2,
wherein the first insulator includes a slider accommodating portion of recess shape by which the slider body portion is accommodated to be slidable along the fitting direction, and a fastening force receiving surface extending along the orthogonal direction, facing the slider accommodating portion, and opposing the slider body portion,
the slider body portion includes a fastening force applying surface extending along the orthogonal direction and opposing the fastening force receiving surface, and
when the fastening force applying surface of the slider body portion which slides in the fitting direction following rotation of the screw member contacts and presses the fastening force receiving surface of the first insulator in the fitting direction, the first opposing surface is pressed against the second opposing surface, and the first insulator is fastened to the second insulator along the fitting direction.

4. The connector assembly according to claim 3,
wherein the second insulator includes a screw member through-hole penetrating the second insulator along the fitting direction,
the first insulator includes a communicating hole penetrating the first insulator along the fitting direction and communicating with an inside of the slider accommodating portion, and
with the screw member being passed through the screw member through-hole and the communicating hole, the male screw portion is screwed to the female screw portion of the slider.

5. The connector assembly according to claim 4,
wherein the screw member includes a screw body portion extending along the fitting direction and provided at least at a tip end thereof with the male screw portion, and a screw head portion joined to a base end of the screw body portion and having a diameter larger than a diameter of the screw body portion, and
the screw head portion is exposed from the second insulator in an opposite direction from the first insulator, and the screw body portion is passed through the screw member through-hole and the communicating hole.

6. The connector assembly according to claim 1,
wherein the second connector includes a frame member held by the second insulator,
the frame member includes a pair of inner wall surfaces extending along the fitting direction and opposing each other in the orthogonal direction, a spring portion that is disposed on one inner wall surface of the pair of inner wall surfaces and is elastically deformable in the orthogonal direction, and a projection that is disposed on another inner wall surface of the pair of inner wall surfaces and projects in the orthogonal direction,
the second contact includes a second contact portion disposed between the spring portion and the projection,
the first contact includes a first contact portion that is situated between the spring portion and the projection and opposes the second contact portion in the orthogonal direction when the second insulator is situated at the contact position with respect to the first insulator, and
when the pressing portion of the slider which slides in the fitting direction following rotation of the screw member is situated between the spring portion and the projection, the spring portion is elastically compressed, and the first contact portion and the second contact portion are pressed against each other in the orthogonal direction due to elastic force of the spring portion to thereby make contact with each other.

7. The connector assembly according to claim 6,
wherein the first contact is situated between the spring portion and the second contact when the second insulator is situated at the contact position with respect to the first insulator, and
the pressing portion is inserted between the second contact and the projection following rotation of the screw member.

8. The connector assembly according to claim 7,
wherein, with the spring portion receiving no force acting in the orthogonal direction, a sum of a gap S1 between the second contact portion and the spring portion and a gap S2 between the second contact and the projection in the orthogonal direction is smaller than a sum of a thickness D1 of the first contact and a thickness D2 of the pressing portion in the orthogonal direction.

9. The connector assembly according to claim 6,
wherein the second insulator includes a frame member accommodating portion of recess shape,
the frame member is accommodated in the frame member accommodating portion to be movable in the orthogonal direction, and
when the pressing portion of the slider which slides in the fitting direction following rotation of the screw member is situated between the spring portion and the projection, due to the pressing portion, the frame member is moved in the orthogonal direction within the frame member accommodating portion while elastically compressing the spring portion.

10. The connector assembly according to claim 1,
wherein the second connector includes a pair of the second contacts disposed on opposite sides of the screw member in the orthogonal direction across the screw member,
the first connector includes a pair of the first contacts corresponding to the pair of the second contacts, and
the slider includes a pair of the pressing portions corresponding to the pair of the first contacts and the pair of the second contacts.
